(19) United States
(12) Patent Application Publication
(10) Pub. No.: US 2016/0334647 A1
(43) Pub. Date: Nov. 17, 2016

(54) BRIGHT DEFECT REPAIR FOR DISPLAYS

(71) Applicant: Pixtronix, Inc., San Diego, CA (US)

(72) Inventors: Hung-Chien Lin, Zhubei City (TW); Javier Villarreal, Somerville, MA (US)

(21) Appl. No.: 14/711,515

(22) Filed: May 13, 2015

(51) Int. Cl. G02F 1/01; G09G 3/34; G02B 26/04; G09G 3/32; G09G 3/36

(52) U.S. Cl. CPC G02F 1/0126; G09G 3/3208; G09G 3/36; G02B 26/04; G02F 1/0147; G09G 3/3433

(57) ABSTRACT

This disclosure provides devices, apparatuses and methods of preventing incorporation of bright defects into an image generated by a display apparatus. A display apparatus may include a chromic film that is selectively activated, with the activated regions of the chromic film being colored, light blocking regions that overlie or underlie bright defect pixels of the display apparatus. The remainder of the chromic film is colorless and light transmissive. The chromic film may be provided as a coating on a substrate of the display apparatus. The chromic film may be selectively activated by exposing regions that overlie or underlie bright defect pixels to laser radiation. The laser radiation may induce a photochemical or thermally activated reaction in the chromic film, selectively changing the irradiated regions from colorless and light transmissive to colored and light blocking.

### TECHNICAL FIELD

This disclosure relates to display devices and more particularly to repairing bright defects in display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Various defects may be present in EMS and other types of devices. For example, while device packaging may protect the functional units of EMS and other devices from the environment, defects may be introduced during packaging processes. One type of defect that can affect display devices including liquid crystal displays (LCDs), organic light emitting diode (OLED) displays, and MEMS displays, is a bright defect, in which a pixel or sub-pixel appears always illuminated.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus that include a backlight, a plurality of display elements, a substrate disposed between the backlight and the plurality of display elements, and a chromic coating on the substrate, where the chromic coating is selectively activated to block light from the backlight from reaching a subset of the plurality of display elements while allowing light transmission from the backlight to the remainder of the plurality of display elements.

In some implementations, the display elements are MEMS display elements. The display elements may include shutter-based light modulators. In some implementations, wherein the subset of the plurality of display elements include display elements of bright defect pixels. In some implementations, the substrate has a first side facing the backlight and a second side facing the display elements, with the chromic coating being on the first side of the substrate. In some implementations, the substrate has a first side facing the backlight and a second side facing the display elements, with the chromic coating being on the second side of the substrate.

The display apparatus may include an aperture layer having a plurality of apertures. In some implementations, the aperture layer is supported by the substrate. In some implementations, the aperture layer is disposed between the chromic coating and the substrate. In some implementations, the chromic coating is disposed between the aperture layer and the substrate. In some implementations, the chromic coating and the aperture layer are on opposite sides of the substrate.

According to various implementations, the chromic coating includes a photochromic or thermochromic material. In some implementations, the chromic coating includes an organic photochromic or thermochromic compound.

In some implementations, the display apparatus includes a processor capable of communicating with the plurality of display elements, the processor being capable of processing image data and a memory device capable of communicating with the processor. The display apparatus may further include a driver circuit capable of sending at least one signal to the plurality of display elements and a controller capable of sending at least a portion of the image data to the driver circuit. In some implementations, the display apparatus includes an image source module capable of sending the image data to the processor, wherein the image source module includes at least one of a receiver, transceiver and transmitter. In some implementations, the apparatus includes an input device capable of receiving input data and communicating the input data to the processor.

Another innovative aspect of the subject matter described in this disclosure can be implemented in a display apparatus that includes a plurality of display elements; a substrate; and a chromic coating on the substrate, where the chromic coating is selectively activated to block light from a subset of the plurality of display elements while allowing light transmission from the remainder of the plurality of display elements.

In some implementations, the display elements are MEMS display elements. The display elements may include shutter-based light modulators. In some implementations, the subset of the plurality of display elements includes display elements of bright defect pixels.

In some implementations, the substrate is a cover plate for the display apparatus. The display apparatus may include an aperture layer having a plurality of apertures. In some implementations, the aperture layer is supported by the substrate. In some implementations, the aperture layer is disposed between the chromic coating and the substrate. In some implementations, the chromic coating is disposed between the aperture layer and the substrate. In some implementations, the chromic coating and the aperture layer are on opposite sides of the substrate.

According to various implementations, the chromic coating includes a photochromic or thermochromic material. In some implementations, the chromic coating includes an organic photochromic or thermochromic compound.

In some implementations, the display apparatus includes a processor capable of communicating with the plurality of display elements, the processor being capable of processing image data and a memory device capable of communicating with the processor. The display apparatus may further include a driver circuit capable of sending at least one signal to the plurality of display elements and a controller capable of sending at least a portion of the image data to the driver circuit. In some implementations, the display apparatus includes an image source module capable of sending the image data to the processor, wherein the image source module includes at least one of a receiver, transceiver and transmitter. In some implementations, the apparatus includes an input device capable of receiving input data and communicating the input data to the processor.

Another innovative aspect of the subject matter described in this disclosure can be implemented in a display apparatus that includes a plurality of pixels, where the subset of the pixels are bright defect pixels; and including means for blocking light from the bright defect pixels. In some implementations, the means include a chromic film.

In some implementations, the means for blocking light from the bright defect pixels include means for preventing light from a backlight from reaching the bright defect pixels. In some implementations, the means for blocking light from the bright defect pixels include means for preventing light from bright defect pixels from reaching a cover plate of the apparatus.

Another innovative aspect of the subject matter described in this disclosure can be implemented in a method of manufacturing a display apparatus that includes coating a substrate of a display apparatus with a chromic film; packaging the display apparatus; identifying bright defect pixels in the display apparatus; and selectively activating regions of the chromic film that overlie or underlie the bright defect pixels. In some implementations, selectively activating regions of the chromic film that overlie or underlie the bright defect pixels includes exposing the regions to laser radiation. In some implementations, the packaged display apparatus includes shutter-based light modulators. The method may further include forming an aperture layer on the substrate. In some implementations, coating the substrate with the chromic film includes depositing the chromic film on the aperture layer. In some implementations, the aperture layer is formed on the chromic film. In some implementations, the aperture layer and the chromic film are on opposite sides of the substrate.

Details of one or more implementations of the subject matter described in this disclosure are set forth in the accompanying drawings and the description below. Other features, aspects and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIGS. 3A and 3B depict side views of examples of displays including a chromic coating positioned between a backlight and display elements of each display.

FIG. 3C depicts a side view of an example of a display including a chromic coating positioned between a cover plate and display elements of the display.

FIG. 4 shows an example of a solar energy distribution.

FIG. 5 shows examples of cross-sectional views of display elements at various stages of a laser repair process.

FIGS. 6A-6C show examples of different configurations of a chromic film on a transparent substrate.

FIG. 7 shows a flow diagram illustrating an example process for manufacturing a display apparatus including a chromic film.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings are not intended to be limited to the implementations depicted solely in the Figures, but instead have wide applicability as will be readily apparent to one having ordinary skill in the art.

A display apparatus may include a chromic film that is selectively activated to prevent incorporation of bright defects into an image generated by the display apparatus. The chromic film may be a photochromic film or a thermochromic film. The selectively activated regions of the chromic film are colored, light blocking regions that overlie or underlie bright defect pixels of the display apparatus. The remainder of the chromic film is colorless and light transmissive. The chromic film may be provided as a coating on a substrate of the display apparatus. In some implementations, the chromic film is disposed between a backlight and display elements of the display apparatus. The activated regions of the chromic film block light from the backlight from reaching display elements of bright defect pixels. In some implementations, the chromic film is disposed between a cover plate and display elements of the display apparatus. The activated regions of the chromic film prevent light from the bright defect pixels from reaching the cover plate.

The chromic film may be selectively activated by exposing regions that overlie or underlie bright defect pixels to laser radiation. The laser radiation may induce a photochemical or thermally activated reaction in the chromic film, selectively changing the irradiated regions from colorless and light transmissive to colored and light blocking.

Particular implementations of the subject matter described in this disclosure can be implemented to realize one or more of the following potential advantages. A chromic film in a display apparatus may prevent the incorporation of bright defects into images generated by the display. The chromic film can block bright defects that cannot be fixed by conventional repair methods. As a result, pixel yield may be improved. The chromic film may be writeable after the display apparatus is packaged, allowing repair of pixels that may be damaged during a packaging process. This can permit identifying only those pixels that are defective after packaging as defective.

In some implementations, bright defects can be repaired without additional tools and patterning processes that ink-based technologies may use. In some implementations, the chromic film can be uniformly applied across a display. This can reduce the likelihood that a repaired pixel will be seen by a viewer. The methods and apparatus disclosed herein may use laser beams that have smaller cross-sectional areas than those of pixels of high resolution displays and may be implemented to repair defects of high resolution displays. In some implementations, laser radiation is used to selectively block defective pixels. Laser technology may be combined with test tools to identify and automatically repair defects, providing scalable and efficient defect repair.

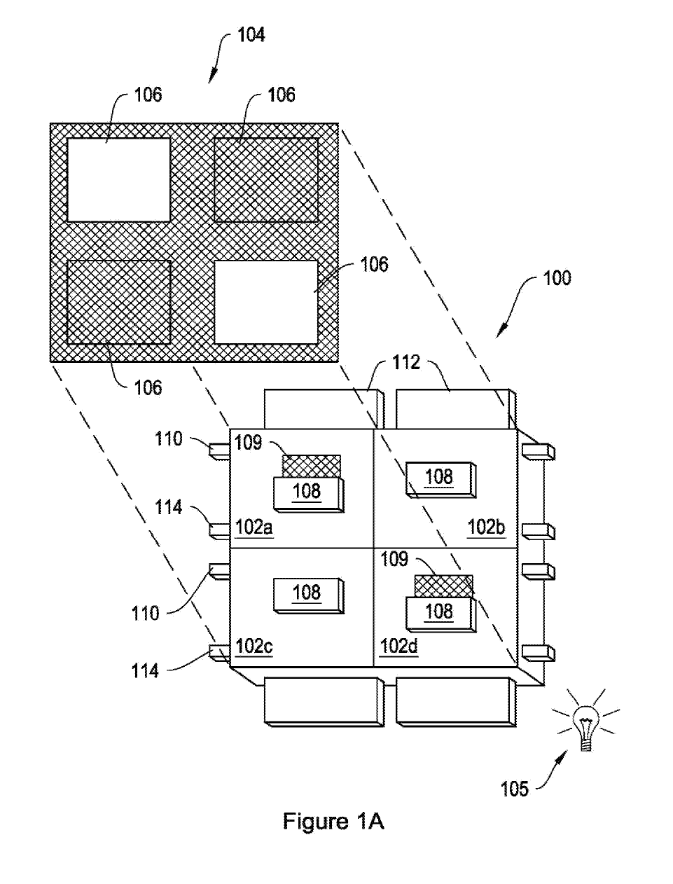

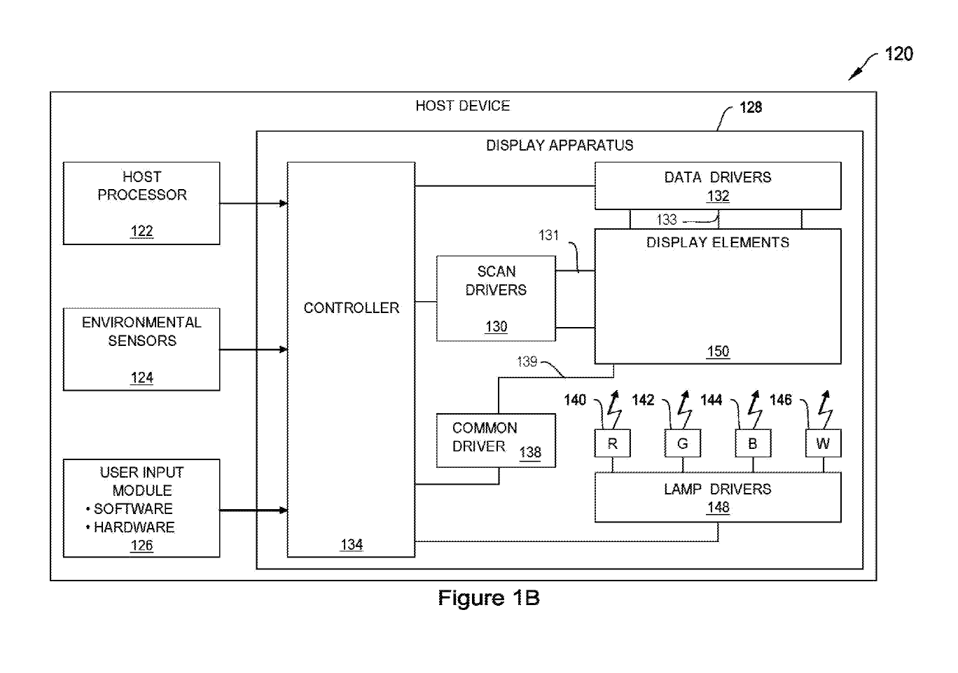

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

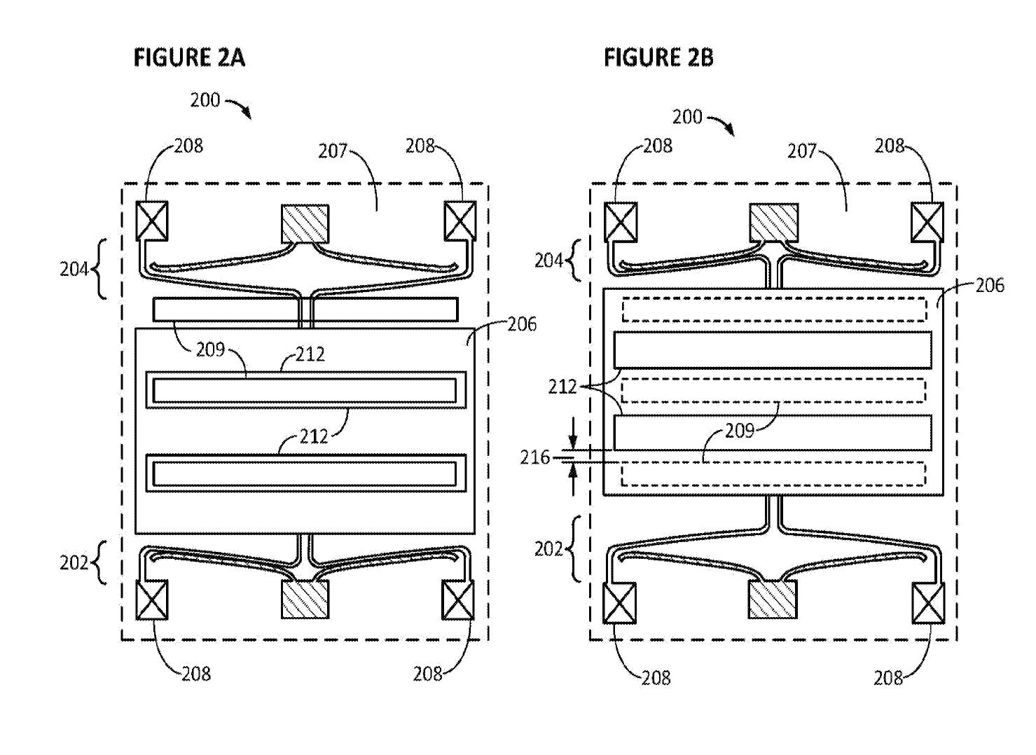

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

A display, such as a direct view MEMS-based display apparatus 100 as described with reference to FIGS. 1A and 1B or a display having a dual actuator shutter assembly 200 as described with reference to FIGS. 2A and 2B, may include a chromic coating that blocks light from defective pixels while allowing light transmission from other pixels. In some implementations, the chromic coating selectively blocks light from bright defect pixels, which are pixels that are always on. For example, a shutter such as shutter 108 in FIG. 1A or shutter 206 in FIG. 2A may be stuck in an open state unable to block light. Bright defect pixels may occur during fabrication of a display, for example, due to particles, patterning errors or electrostatic discharge. In other examples, non-uniform transistor behavior, metal line shorting, capacitance leakage, or power supply issues may result in bright defect pixels. Bright defect pixels also may result during packaging of a display device. In some implementations, the packaging can include a fluid filling stage, which may induce stiction and adversely affect the operation of display pixels, such as MEMS light modulators.

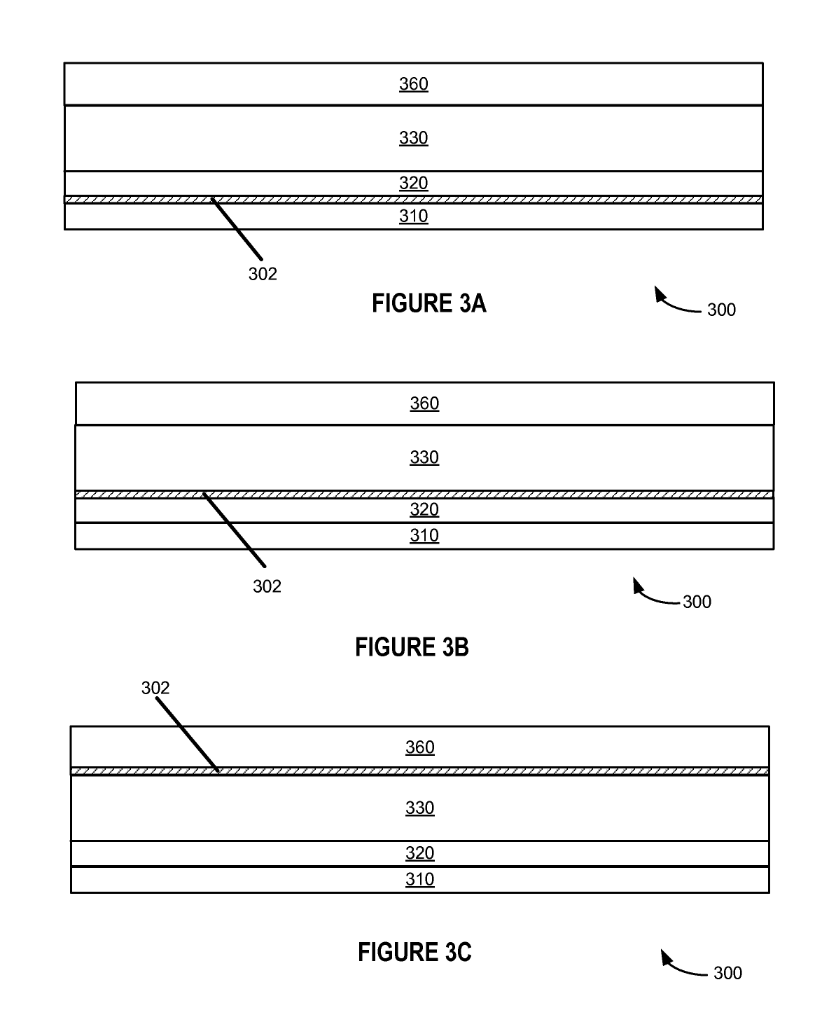

In some implementations, a display may include a chromic coating positioned between a backlight and display elements of the display. The chromic coating may be selectively activated to block light from the backlight from reaching one or more display elements of bright defect pixels. FIGS. 3A and 3B depict side views of examples of displays including a chromic coating positioned between a backlight and display elements of each display. In FIGS. 3A and 3B, a display 300 is shown in cross-section. The display 300 includes a cover plate 360 that forms the front side of the display 300 and can protect the other components of the display 300. The cover plate 360 may overlie display elements 330. In some implementations, the display elements 330 may include MEMS shutter-based light modulators, such as the light modulators 102 in FIG. 1A or the dual actuator shutter assemblies 200 in FIG. 2A. In some other implementations, the display elements 330 may be LCD display elements, OLED display elements, other MEMS-based display elements, or display elements of any suitable light-modulation technology.

The display 300 also includes a backlight 310, which may include several components, such as a light source, a light guide, and a brightness-enhancing film. In implementations in which the display elements are shutter-based light modulators, the display 300 may include apertures, such as the apertures 109 in FIG. 1A or the apertures 209 in FIG. 2A, through which light from the backlight 310 may travel.

The display 300 includes a transparent substrate 320 positioned between the backlight 310 and the display elements 330. According to various implementations, the transparent substrate 320 or the cover plate 360 may provide support for the display elements 330.

In the examples of FIGS. 3A and 3B, a chromic film 302 is provided as a coating on the transparent substrate 320. In FIG. 3A, the chromic film 302 is coated on a side of the transparent substrate 320 that faces the backlight 310. In FIG. 3B, the chromic film 302 is coated on a side of the transparent substrate 320 that faces the display elements 330. As discussed further below, according to various implementations, the chromic film 302 may be coated directly on the transparent substrate 320 or there may be one or more layers of materials interposed between the chromic film 302 and the transparent substrate 320.

Most of the chromic film 302 is transparent to light and allows transmission of light from the backlight 310 to the display elements 330. As discussed further below, local regions of the chromic film 302 are dark and block light from the backlight 310 from reaching one or more display elements of bright defect pixels. Because light is blocked from reaching the bright defect pixels, the image generated by the display does not include bright spots that would otherwise be visible.

In some implementations, a display may include a chromic coating positioned between a cover plate and display elements of the display. FIG. 3C depicts a side view of an example of a display including a chromic coating positioned between a cover plate and display elements of the display. As described above with respect to the examples of FIGS. 3A and 3B, the display 300 in FIG. 3C includes a cover plate 360, display elements 330, a transparent substrate 320, and a backlight 310. A chromic film 302 is positioned between the display elements 330 and the cover plate 360. The chromic film 302 may be provided as coating on the cover plate 360. In the example of FIG. 3C, the chromic film 302 is coated on a side of the cover plate 360 that faces the display elements. In some other implementations, it may be provided as a coating on the exterior of the cover plate 360.

While most of the chromic film 302 is transparent to light and allows transmission of light through the cover plate 360, local regions of the chromic film 302 are dark and block light from one or more display elements of bright defect pixels to reach the cover plate 360. As a result, the image generated by the display does not include bright spots that would otherwise be visible.

As described above, in some implementations, a pixel may include multiple display elements. For example, referring to FIG. 1A, three color-specific light modulators 102 may correspond to a particular pixel 106. If one of the light modulators or other display elements in such a pixel is always on, the pixel may be considered to have a bright defect sub-pixel and two working sub-pixels. As used herein, the term bright defect pixel may refer to a pixel that includes a bright defect sub-pixel. According to various implementations, the light blocking region of the chromic coating that corresponds to a pixel that includes a bright defect sub-pixel may be large enough to block light from the entire pixel or from the defective sub-pixel.

A light blocking region may be large enough to substantially prevent light transmission from the bright defect pixel or sub-pixel without blocking light from undamaged pixels or sub-pixels. Substantially preventing light transmission refers to allowing less than 15% transmission of the light from the bright defect pixel or sub-pixel to reach a viewer. In some implementations, at least 90% of the light from the bright defect pixel or sub-pixel is blocked by the light blocking region.

In some implementations, a single light blocking region may block multiple pixels or sub-pixels including one or more defective pixels or sub-pixels and optionally one or more working pixels or sub-pixels. In implementations in which a light blocking region blocks working pixels, they may be pixels that are not typically seen by the viewer.

The area of a light blocking region depends on the pixel density of the display, with the area large enough to block one or more pixels or sub-pixels as described above. Example areas may range from 0.001 to 0.04 inches, or 0.001 to 0.02 inches.

In some implementations, some amount of light leakage around the periphery of a light blocking region may be visible when the display is viewed at an oblique angle. Light leakage around the periphery of a light blocking region may increase with distance from the backlight (or an aperture layer that directs light from the backlight) as the light to be blocked becomes more diffuse. The chromic films 302 in FIGS. 3A and 3B are exposed to less diffuse light than the chromic film 302 in FIG. 3C or a chromic film on the exterior of the cover plate 360. For example, a distance between the chromic film 302 and the backlight 310 in FIG. 3A may between about 10-20 microns, while a distance between the chromic film 302 and the exterior side of the cover plate 360 may be between about 200-700 microns. Coating a substrate that is proximal to a backlight (as in the examples of FIGS. 3A and 3B) with a chromic film may facilitate reduction or elimination of light leakage from bright defect pixels.

The chromic materials that may be used in implementations described herein are photochromic materials, thermochromic materials, and combinations thereof. A chromic coating is a chromic material that is coated on a substrate. Photochromic materials that may be used in implementations described herein are materials that are capable of undergoing a photochemical reaction where an absorption band in the visible part of the electromagnetic spectrum changes in strength or wavelength such that the material becomes colored. The photochemical reaction occurs under exposure to electromagnetic radiation of a wavelength that corresponds to an electronic transition in the material. A photochromic coating is a photochromic material that is coated on a substrate.

Thermochromic materials that may be used in implementations described herein are materials that are capable of undergoing a thermally-activated chemical reaction where an absorption band in the visible part of the electromagnetic spectrum changes in strength or wavelength such that the material becomes colored. The chemical reaction occurs under exposure to thermal energy sufficient to provide the activation energy for the reaction. A thermochromic coating is a photochromic material that is coated on a substrate.

The chromic materials are generally colorless prior to the chemical reaction, although in some implementations they may have a slight yellowish appearance or otherwise be tinted. They are distinct from color pigments, such as red, green and blue pigments that may be used as color filters in certain display technologies. A chromic material includes a photochromic or thermochromic compound, and also may include one or more other components such as polymeric binders, developers, and stabilizers.

In some implementations, the chromic material is a laser-writable material. Exposure to laser radiation results in a change from a colorless transparent material to a colored light blocking material. The laser may be used as a source of electromagnetic radiation of a wavelength that corresponds to an electronic transition in a photochromic compound or as a focused thermal energy source to heat a thermochromic compound. A chemical reaction (i.e., a photochemical reaction in the case of a photochromic material or a thermally-induced reaction in the case of a thermochromic material) results in molecular reconstruction or valence electron change in the chromic compound that results in a local color change of the material. Examples of chemical reactions include oxidation-reduction reactions, cis-trans isomerizations, intramolecular hydrogen or group transfers, and pericyclic reactions.

The chromic materials may be organic or inorganic. Examples of photochromic organic compounds include spiropyrans, spirooxazines, fulgides, diarylethenes, azobenzenes, and quinones. Examples of photochromic inorganic compounds include metal phosphates, metal phosphites, titanium dioxide, zinc and silver halides, and ruthenium sulfoxide coordination compounds. Examples of thermochromic compounds are provided further below.

A photochromic material may be a reversible or an irreversible photochromic material. A reversible photochromic material includes a compound that is capable of undergoing a reversible photochemical reaction. According to various implementations, the photochemical reaction may be reversed such that a colored portion of the material becomes colorless by exposure to light or heat. A reversible reaction may be represented by

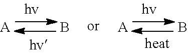

where A is a colorless form of a compound, B is the colored form of the compound, h is Planck's constant, and v and v′ are the frequencies of the applied electromagnetic radiation for the forward and reverse reactions, respectively. Reversible photochromic compounds that are used in the displays disclosed herein are generally those that do not undergo the either the forward reaction (A→B) or the reverse reaction (B→A) under normal display operating conditions, such as exposure to indoor or outdoor lighting or ambient temperatures. In some implementations, the optical operation range of a reversible photochromic material is outside the visible spectrum.

Irreversible photochromic compounds are compounds that undergo an irreversible photochemical reaction to produce a color change. Certain heteropoly acid compounds are examples of irreversible photochromic compounds. According to various implementations, a heteropoly acid compound used in a photochromic material may be Keggin-type compound represented by the structural formula XM₁₂O₄₀ⁿ where X=phosphorus (P) or silicon (Si); M=chromium (Cr), tungsten (W), vanadium (V), titanium (Ti), zirconium (Zr), niobium (Nb), tantalum (Ta), and manganese (Mn). Other heteropoly acid structures including Dowson-type, Anderson-type, Waugh-type, and Silverton-type compounds may also be used.

According to various implementations, the photochemical reaction is irreversible such that a colored portion of the material becomes colorless by exposure to light or heat. An irreversible reaction may be represented by

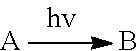

where A is a colorless form of a compound, B is the colored form of the compound, h is Planck's constant, and v is the frequency of the applied electromagnetic radiation for the forward reaction.

In implementations in which a thermochromic material is used, the material does not revert to a colorless form once a heat source is removed. Examples of compounds that may be used are thermochromic leuco compounds with appropriate developers. Leuco compounds are dyes that have two forms, a colorless form and a chromic form. Examples of leuco compounds include trisubstituted pyridine compounds, phthalide compounds, fluorane compounds, triphenyl methane compounds, phenothiadine compounds, auramine compounds, and spiro compounds such as spiropyran compounds and spriooxanzine compounds. While many leuco compounds are reversibly thermochromic, activation temperatures for both the forward and reverse reactions may be at hundreds of degrees Celsius, well above the normal operating temperature of a display. In some implementations, a thermochromic compound having an activation temperature of at least 80° C. is employed.

Once coated on an appropriated substrate, the chromic material is selectively activated to change the color of the coating in regions that overlie or underlie (depending on the location of the coating in the display stack and the orientation of the stack) bright defect pixels.

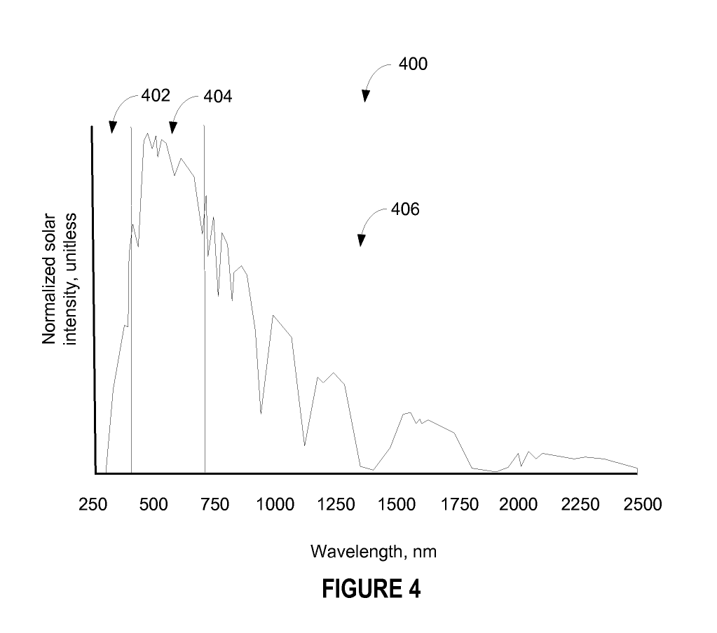

As discussed further below, a laser may be used to induce a photochemical reaction in one or more isolated regions of a photochromic coating to selectively activate and change the color of those regions. A laser that emits radiation at a wavelength that induces the photochemical reaction is used. As noted above, photochromic compounds that are used in the displays are generally those that do not undergo photochemical reactions under normal display operating conditions. In some implementations, the photochromic material undergoes a photochemical reaction under exposure to wavelengths outside peak wavelengths of a solar energy distribution. FIG. 4 shows an example of a solar energy distribution. In solar energy distribution 400, normalized solar intensity is shown as a function of wavelength, with the ultraviolet region 402 (300-400 nm), the visible region 404 (400-700 nm) and the near infrared region 406 (700-2250 nm) indicated.

To induce a change in a photochromic material, the material is exposed to light of a wavelength corresponding to an electronic transition of the material and having sufficient energy to overcome the chemical potential of the reaction. Photochromic materials that undergo color change at wavelengths that have relatively small solar intensities may be employed in some implementations. This is because exposure to sunlight during normal usage of the display apparatus will expose the photochromic material to insufficient energy at the wavelengths that will induce a reaction in the photochromic material. For example, referring to FIG. 3, a photochromic coating may be exposed to a high intensity 350 nm laser to selectively activate and color isolated regions of the coating while leaving most of the coating uncolored. Although the photochromic coating may be exposed to 350 nm radiation during normal usage, that radiation is not of sufficient energy to induce a photochemical reaction in the photochromic coating. According to various implementations, photochromic compounds that undergo color change at wavelengths greater than 1300 nm or less than 300 nm may be used. As can be seen from the example in FIG. 4, at these wavelengths, the solar intensity is relatively low. In one example, a 266 nm laser may be used to induce the photochemical reaction. Photochromic materials that undergo color change at relatively high intensity wavelengths may be used for in some implementations, for example in displays that are not exposed to sunlight during normal usage.

Further, in some implementations, photochromic compounds that having electronic transitions at relatively high intensity wavelengths may be employed even with displays that are exposed to light at these wavelengths during normal usage. This is because the exposure to sunlight may not be focused enough to induce a photochemical reaction in the film.

A laser be used to provide thermal energy to one or more isolated regions of a thermochromic coating to induce a chemical reaction in those regions, thereby selectively activating and changing the color of the coating in those regions. In general, the activation temperature is greater than the maximum temperature the display apparatus could reach in use. Example activation temperatures may be 100° C. or above. A laser of any appropriate wavelength may be used, with examples including 266 nm, 532 nm and 1064 nm.

In some implementations, a display may include both a photochromic film and a thermochromic film. If a particular laser repair tool cannot activate the photochromic film, sufficient laser power may be used to selectively activate the thermochromic film.

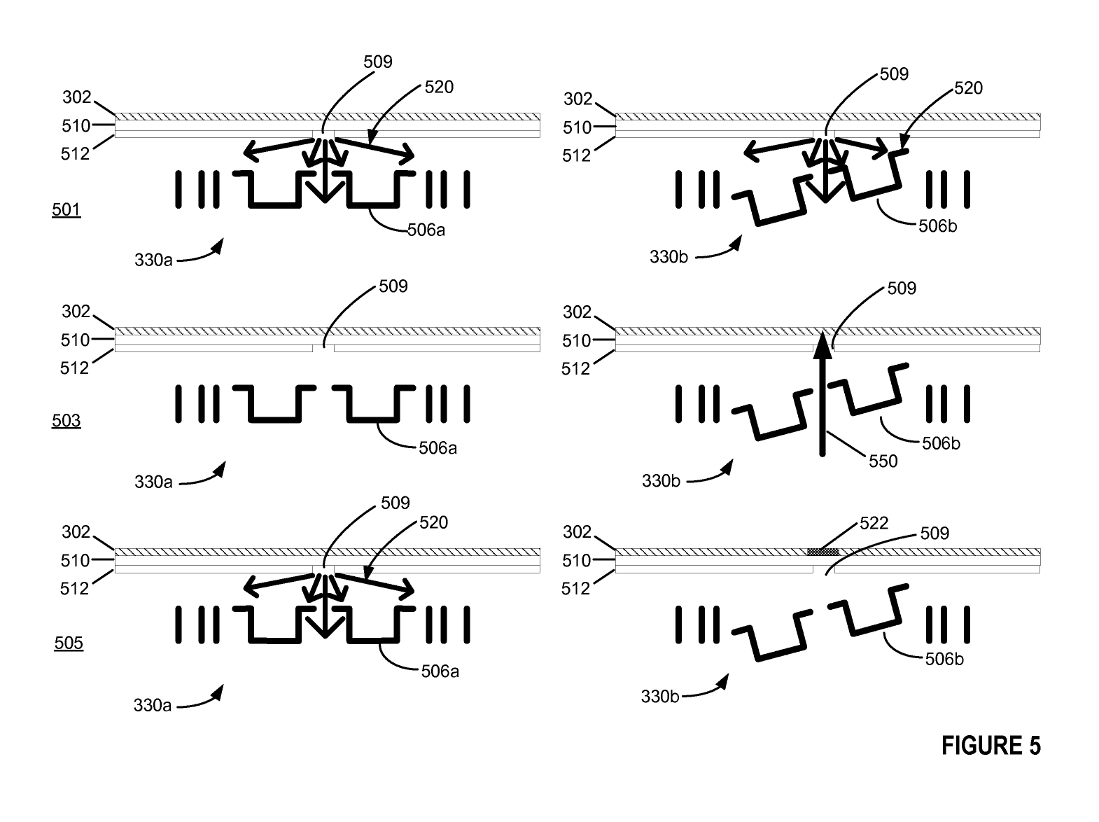

FIG. 5 shows examples of cross-sectional views of display elements at various stages of a laser repair process. As discussed further below, the laser repair process depicted in FIG. 5 may occur after a packaging process that joins together various components of the display apparatus (such as a backlight, display elements, a cover plate and the like) to form a packaged display apparatus. Various defects may be introduced during packaging processes. In FIG. 5, two display elements 330a and 330b of a display apparatus are depicted at three stages 501, 503 and 505. As depicted, the display elements 330a and 330b include shutters 506a and 506b and may be, for example, shutter-based light modulators as described above with respect to FIGS. 1A, 2A and 2B. In some other implementations, the display elements may be LCD display elements, OLED display elements, other MEMS-based display elements, or display elements of any suitable light-modulation technology. An aperture plate 510 is coated with a chromic film 302. The aperture plate 510 is a transparent substrate, such as transparent substrate 320 in FIGS. 3A and 3B, that supports an aperture layer 512 having apertures 509 defined therein. Other components of a packaged display apparatus such as a backlight and cover plate are not depicted for ease of illustration.

At stage 501, the display elements 330a and 330b are depicted prior to a laser repair process. Light 520 from a backlight (not shown) is transmitted through the apertures 509 and through shutters 506a and 506b, which are open. While the shutter 506a is functional and able to be moved into a closed stated, the shutter 506b is stuck open, unable to close. The result is that the pixel that includes the shutter 506b is a bright defect pixel. In some implementations, the presence and location of bright defect pixels may be determined in post-packaging testing.

At stage 503, laser radiation 550 is selectively applied to a portion of the chromic film 302. This forms a colored light blocking region 522 that prevents the light 520 emitted from the backlight from reaching the stuck open shutter 506b. The remainder of the chromic film 302 is not irradiated and remains colorless and transmissive to the light 520.

As discussed above with respect to FIGS. 3A-3C, the chromic film may be located in various positions within a display stack, including on either side of a cover plate, aperture plate or other transparent substrate within the display apparatus. According to various implementations, for example, a chromic film may be coated on a side of a substrate that faces the display elements of a display apparatus (as in the examples of FIGS. 3B and 3C) or on a side of a substrate that faces away from the display elements of the display apparatus (as in the example of FIG. 3A). Further, the chromic film may be coated directly on the substrate, or over one or more layers deposited on the substrate.

According to various implementations, the location of the chromic film within a display apparatus may be selected based on considerations including processing compatibility and light leakage. Coating a substrate that supports display elements may involve more processing complexities than coating a substrate that does not support display elements. Referring to FIG. 3B, for example, if the transparent substrate 320 supports the display elements 330 such that the display elements 330 are fabricated on the transparent substrate 320 after the chromic film 302 is deposited thereon, processing may involve protecting the chromic film 302 during fabrication of the display elements. As an example, a chromic film 302 that includes organic material, such an organic photochromic or thermochromic compound or organic polymer binder, may be masked to avoid etchant chemicals in a release etch operation during fabrication of MEMS shutter-based light modulators such as those shown in FIGS. 1A, 2A and 2B. Similarly, referring to FIG. 3A, if the cover plate 360 supports the display elements 330, the chromic film 302 may be masked during fabrication of the display elements 330.

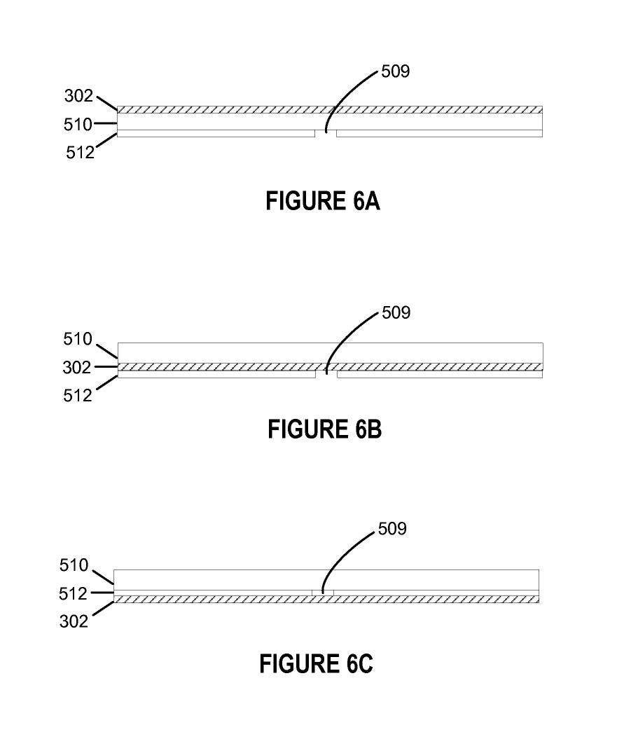

Coating a substrate that does not support display elements and that can be processed separately from the display elements may be relatively straightforward. Examples include the display apparatuses in FIGS. 3A and 3B in implementations in which the display elements 330 are supported by the cover plate 360 and the display apparatus in FIG. 3C in implementations in which the display elements are supported by the transparent substrate 320. Further processing considerations are discussed below with reference to FIGS. 6A-6C.

FIGS. 6A-6C show examples of different configurations of a chromic film on a transparent substrate. In the examples of FIGS. 6A-6C, the transparent substrate on which a chromic film 302 is coated is an aperture plate 510 of a MEMS shutter-based display in which the MEMS display elements are supported by another substrate (for example, a cover plate) and not by the aperture plate 510. However, it will be understood that the below discussion may be applied to various other arrangements that are described above.

In FIG. 6A, the chromic film 302 is coated directly on a first side the aperture plate 510, with an aperture layer 512 coated on the opposite side of the aperture plate 510. In some implementations, the aperture layer 512 faces display elements (not shown) of the display while the chromic film 302 faces away from the display elements. This configuration is illustrated in FIG. 5, for example. The chromic film 302 may face a backlight (not shown). According to various implementations, the aperture layer 512 may include one or more reflective or light-absorbing layers. For example, the aperture layer 512 may include a reflective layer facing the backlight to recycle light from the backlight and a light-absorbing layer facing the display elements. Because the aperture layer 512 and the chromic film 302 are deposited on opposite sides of the aperture plate 510 and not on top of one another, processing is relatively straightforward.

FIG. 6B shows an example of a configuration in which the aperture layer 512 is deposited over the chromic film 302. In this configuration, the chromic film 302 is adjacent to the aperture layer 512, which can be useful to minimize light leakage. In some implementations, both the aperture layer 512 and the chromic film 302 are on the side of the aperture plate 510 that faces the display elements of the display. In implementations in which an aperture layer or other thin films are to be deposited on the chromic film 302, a photochromic or thermochromic material that can sustain thin film deposition thereon is used. In some implementations, a protective layer may be deposited over the chromic film 302 prior to deposition of the aperture layer 512 to protect the chromic film 302 during etch of the aperture layer 512. The protective layer may be a material to which the aperture layer can be etched selectively, and may be selected based on the particular etching process. Examples of materials include titanium oxides (TiOx), aluminum oxides (AlOₓ), silicon oxides (SiOx) and silicon nitrides (SiNx).

FIG. 6C shows an example of a configuration in which the chromic film 302 is deposited over the aperture layer 512. In this configuration, the chromic film 302 is adjacent to the aperture layer 512; as in the example of FIG. 6B, this can be useful to minimize light leakage. In some implementations, both the aperture layer 512 and the chromic film 302 are on the side of the aperture plate 510 that faces the display elements of the display. Deposition of the chromic film 302 on the aperture layer 512 may be performed in implementations in which a photochromic or thermochromic material that may not provide support for the aperture layer 512 is used. In some implementations, a protective layer may be deposited over the chromic film 302 to prevent unwanted reactions between the chromic film 302 and the display elements. An example of a protective layer is a low temperature SiOₓ layer.

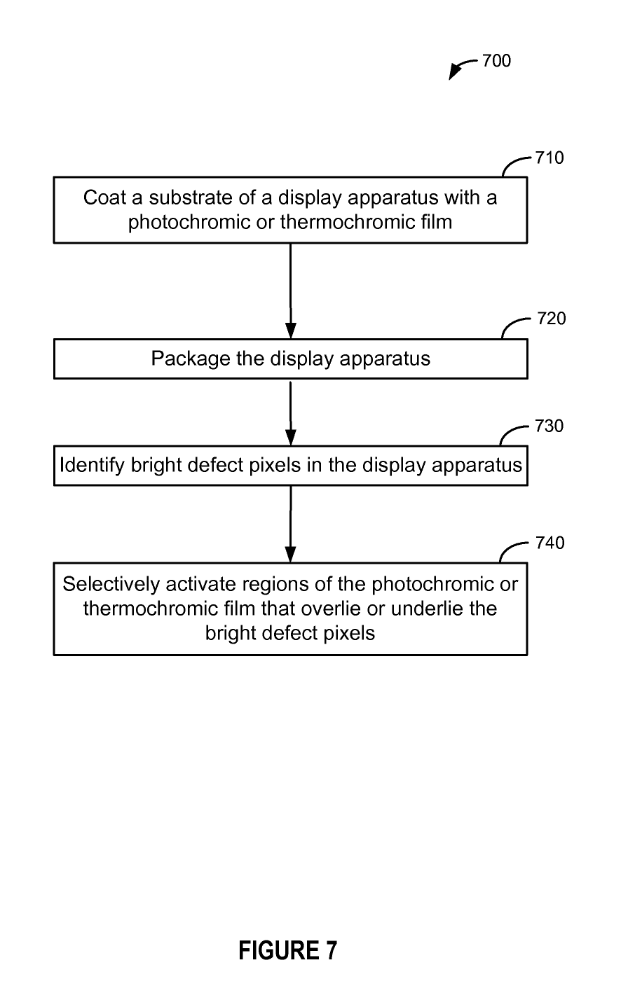

FIG. 7 shows a flow diagram illustrating an example process for manufacturing a display apparatus including a chromic film. At block 710, a substrate of a display apparatus is coated with a chromic film. The substrate can include any suitable substrate material, such as glass or plastic. The substrate may be substantially transparent to visible light, at least in the regions of the substrate that overlie or underlie pixels of the display apparatus. Substantial transparency as used herein may be defined as transmittance of visible light of about 70% or more, such as about 80% or more, or even about 90% or more. Glass substrates may be or include a borosilicate glass, a soda lime glass, photoglass, quartz, Pyrex®, or other suitable glass material. As discussed above with reference to the examples of FIGS. 3A-3C, in some implementations, the substrate may be an aperture plate or a cover plate of a display apparatus. However, the substrate may be any substrate to be included in the display apparatus, including a substrate that serves to support the chromic film. According to various implementations, the chromic film may be deposited directly on the substrate or on one or more layers of material already formed on the substrate. The coating process may involve any appropriate process including vapor deposition techniques, wet coating techniques, and dry coating techniques. In some implementations, the chromic material is an organic material that may take the form of a liquid or sol-gel material that includes a solvent. Wet coating techniques such as dip coating, spray coating, flow coating, spin coating or roll coating may be used to disperse the material on the substrate, followed by a drying process to remove the solvent and form a solid chromic film. Vapor deposition techniques such as chemical vapor deposition (CVD) or physical vapor deposition (PVD) may be used as appropriate, for example, to deposit metal oxide films. The chromic film is coated to an appropriate thickness. As indicated above, example thicknesses can range from about 300-1000 microns. Typically, one side of the substrate is coated with the chromic coating. The chromic coating may cover the entire area of the substrate, or at least the entire area that will overlie or underlie pixels of the display.

In block 720, the display apparatus is packaged. Packaging can protect the functional units of the display from the environment. In some implementations, block 720 involves bonding the substrate coated in block 710 to a second substrate. For example, the coated substrate may be an aperture plate that is bonded in block 720 to a cover plate. In another example, the coated substrate may be a cover plate that is bonded in block 720 to an aperture plate. The display elements of the pixels of the display apparatus may be on either substrate according to various implementations.

In block 730, bright defect pixels in the display apparatus are identified. As discussed above, bright defect pixels are pixels that cannot be turned from on to off. Block 730 may involve identifying bright defect sub-pixels. For example, in a MEMS shutter-based display, a pixel may include three sub-pixels, each of which includes a shutter. In some implementations, block 730 may involve identifying sub-pixels that are always on due, for example, to a shutter that is stuck in the open position.

In block 740, regions of the chromic film that overlie or underlie (depending on the orientation of the display apparatus and the location of the film within the display stack) the bright defect pixels are selectively activated. Selectively activation refers to activating and thereby inducing a color change in those regions while leaving the remaining portions of the chromic film inactivated and colorless. Block 740 can involve exposing the regions to laser radiation or any appropriate focused energy source.

In some implementations, a repair operation may be performed prior to block 740 to unstick shutters that are stuck open or otherwise make bright defect pixels into working pixels. In such cases, any pixels that are repaired are no longer bright defect pixels. Typically, however, at least some of the bright defect pixels cannot be repaired in this manner. If such a repair operation is performed that uses laser radiation, it is at a wavelength that will not activate the chromic film.

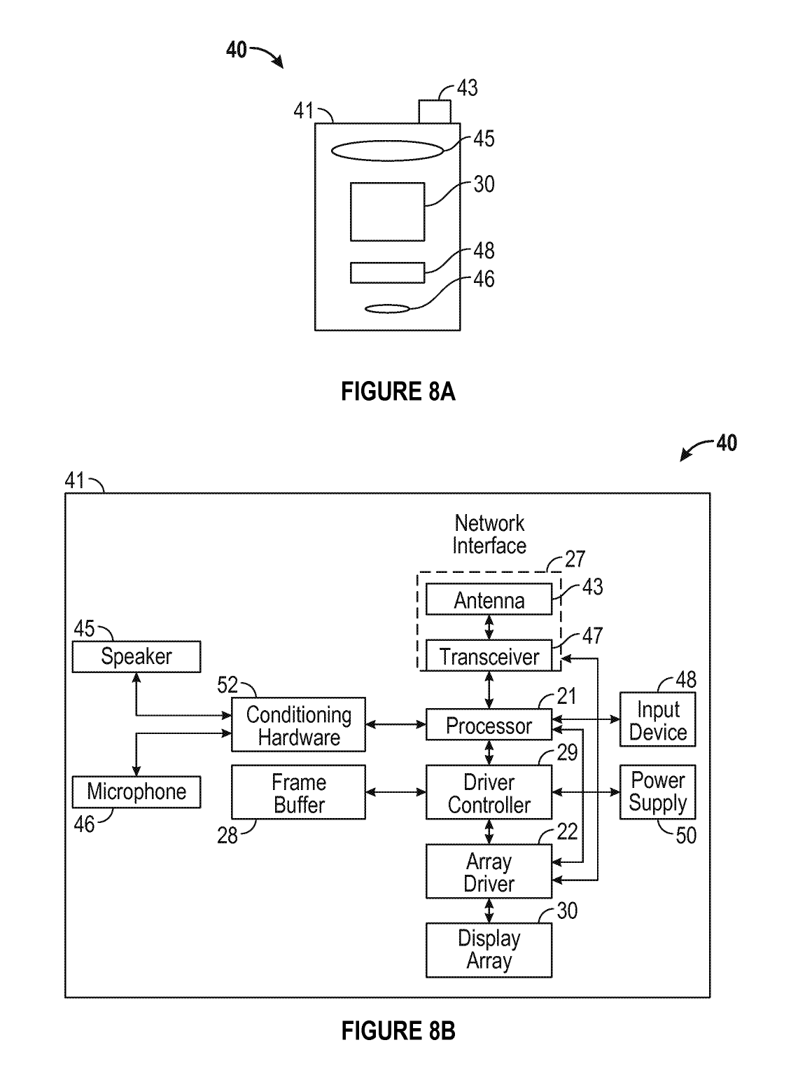

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein. The display may include a chromic coating, as described above.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower,” “front” and “behind,” “above” and “below” and “over” and “under,” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display apparatus, comprising:
a backlight;
a plurality of display elements;
a substrate disposed between the backlight and the plurality of display elements; and
a chromic coating on the substrate, wherein the chromic coating is selectively activated to block light from the backlight from reaching a subset of the plurality of display elements while allowing light transmission from the backlight to the remainder of the plurality of display elements.

2. The display apparatus of claim 1, wherein the display elements are MEMS display elements.

3. The display apparatus of claim 1, wherein the display elements include shutter-based light modulators.

4. The display apparatus of claim 1, wherein the subset of the plurality of display elements include display elements of bright defect pixels.

5. The display apparatus of claim 1, wherein the substrate has a first side facing the backlight and a second side facing the display elements and the chromic coating is on the first side of the substrate.

6. The display apparatus of claim 1, wherein the substrate has a first side facing the backlight and a second side facing the display elements and the chromic coating is on the second side of the substrate.

7. The display apparatus of claim 1, further comprising an aperture layer having a plurality of apertures.

8. The display apparatus of claim 7, wherein the aperture layer is supported by the substrate.

9. The display apparatus of claim 8, wherein the aperture layer is disposed between the chromic coating and the substrate.

10. The display apparatus of claim 8, wherein the chromic coating is disposed between the aperture layer and the substrate.

11. The display apparatus of claim 8, wherein the chromic coating and the aperture layer are on opposite sides of the substrate.

12. The display apparatus of claim 1, wherein the chromic coating includes an organic photochromic or thermochromic compound.

13. The display apparatus of claim 1, wherein the chromic coating includes a photochromic material.

14. The display apparatus of claim 1, wherein the chromic coating includes a thermochromic material.

15. The display apparatus of claim 1, further comprising:
a processor capable of communicating with the plurality of display elements, the processor being capable of processing image data; and
a memory device capable of communicating with the processor.

16. The display apparatus of claim 15, further comprising:
a driver circuit capable of sending at least one signal to the plurality of display elements; and
a controller capable of sending at least a portion of the image data to the driver circuit.

17. The display apparatus of claim 15, further comprising:
an image source module capable of sending the image data to the processor, wherein the image source module includes at least one of a receiver, transceiver and transmitter.

18. The apparatus of claim 15, further comprising:
an input device capable of receiving input data and communicating the input data to the processor.

19. A display apparatus, comprising:
a plurality of display elements;
a substrate; and
a chromic coating on the substrate, wherein the chromic coating is selectively activated to block light from a subset of the plurality of display elements while allowing light transmission from the remainder of the plurality of display elements.

20. The display apparatus of claim 19, wherein the substrate is a cover plate for the display apparatus.

21. The display apparatus of claim 19, wherein the display elements are MEMS display elements.

22. The display apparatus of claim 19, wherein the subset of the plurality of display elements include display elements of bright defect pixels.

23. The display apparatus of claim 19, further comprising an aperture layer having a plurality of apertures.

24. The display apparatus of claim 23, wherein the aperture layer is supported by the substrate.

25. The display apparatus of claim 24, wherein the aperture layer is disposed between the chromic coating and the substrate.

26. The display apparatus of claim 24, wherein the chromic coating is disposed between the aperture layer and the substrate.

27. An apparatus, comprising:
a plurality of pixels, wherein the subset of the pixels are bright defect pixels; and
means for blocking light from the bright defect pixels, the means including a chromic film.

28. The apparatus of claim 27, wherein the means for blocking light from the bright defect pixels include means for preventing light from a backlight from reaching the bright defect pixels.

29. The apparatus of claim 27, wherein the means for blocking light from the bright defect pixels include means for preventing light from bright defect pixels from reaching a cover plate of the apparatus.

30. A method of manufacturing a display apparatus, comprising:
coating a substrate of a display apparatus with a chromic film;
packaging the display apparatus;
identifying bright defect pixels in the display apparatus; and
selectively activating regions of the chromic film that overlie or underlie the bright defect pixels
